(19) United States
(12) Patent Application Publication
(10) Pub. No.: US 2004/0049494 A1
(43) Pub. Date: Mar. 11, 2004

(54) Method, system and computer-readable medium for traversing a list of search results

(76) Inventor: Vamsi Mohan Kottisa, Bangalore (IN)

Correspondence Address: HEWLETT-PACKARD COMPANY, Intellectual Property Administration, P.O. Box 272400, Fort Collins, CO, 80527-2400, US

(21) Appl. No.: 10/238,251

(22) Filed: Sep. 10, 2002

(51) Int. Cl. G06F 7/00

(52) U.S. Cl. 707/3

(57) ABSTRACT

A method and a system for traversing search results from a search query are disclosed. The method includes receiving the search results arranged in a first order and allowing traversing of the search results in a selected second order different from the first order. The system includes a search engine that receives search results arranged in a first order and means for reordering the search results in a selected second order different from the first order. The system also includes a user interface through which the reordered search results is traversable.

### BACKGROUND

This invention relates to traversing of search results, and more particularly, to traversing a deluge of Internet search results.

The Internet attracts millions of users every day. The primary attraction to the Internet is the promise of huge quantities of available information on any imaginable topic of interest. Research has shown that the primary uses of the Internet by users include searching for information and browsing (a form of searching) for information. Users use a search engine, such as Yahoo and Excite for such searching.

The Internet, however, suffers a notable disadvantage. Some searches return far too much information. For example, the Alta Vista search engine returns about four million hits (i.e., records) in response to a search for sites containing the keyword “tennis.” This deluge of information is often just too much for a user to review, cull, and select.

To better organize the records, some search engines return search results ranked using relevance-ranking algorithms. Some of these relevance-ranking algorithms are primitive and often produce search results that are ranked with little or no relevance. Poorly ranked search results are a significant problem for users and are no better than seemingly randomly-ordered search results that are not ranked. Regardless of whether the search results are ranked or not, the search results appear in the exact same order each time a same search query is made.

Most search engines provide a user interface (UI) that includes a “next” button and a “previous” button that allow a user to only sequentially traverse portions or pages of the search results. Alta Vista provides several page indicia each of which is selectable to allow a user to skip to a corresponding page of search results. However, to reach search results located towards the end of a long list of search results using these search engines would require some tedious effort. It has been shown most users give up after visiting the first few pages of search results. Thus, if highly relevant information were located in a later page, most users would never know and would most likely conclude that the search was a failure.

### SUMMARY

According to an aspect of the present invention, there is provided a method for traversing search results from a search query. The method includes receiving the search results arranged in a first order and allowing traversing of the search results in a selected second order different from the first order.

According to another aspect of the present invention, there is provided a program storage device. The program storage device is readable by a computing device and tangibly embodies a program of instructions that is executable by the computing device to perform the method described above.

According to yet another aspect of the present invention, there is provided a system for traversing search results. The system includes a search engine that receives search results arranged in a first order and means for reordering the search results in a selected second order different from the first order. The system also includes a user interface through which the reordered search results is traversable.

### BRIEF DESCRIPTION OF DRAWINGS

The invention will be better understood with reference to the drawings, in which:

FIG. 1 is a block diagram illustrating a prior art system including a web search engine for automatic searching of information on the Internet;

FIG. 2 is a block diagram illustrating a system for searching and traversing search results returned by the web search engine in FIG. 1 according to an embodiment of the present invention;

FIG. 3 is a flowchart showing a sequence of steps in the system of FIG. 2 for traversing the search results;

FIG. 4 is a schematic drawing showing a user interface through which the search results in FIGS. 2 and 3 are presented to a user for traversing; and

FIG. 5 is a block diagram of elements of a computing system that may be used to perform the steps in FIG. 3.

### DETAILED DESCRIPTION

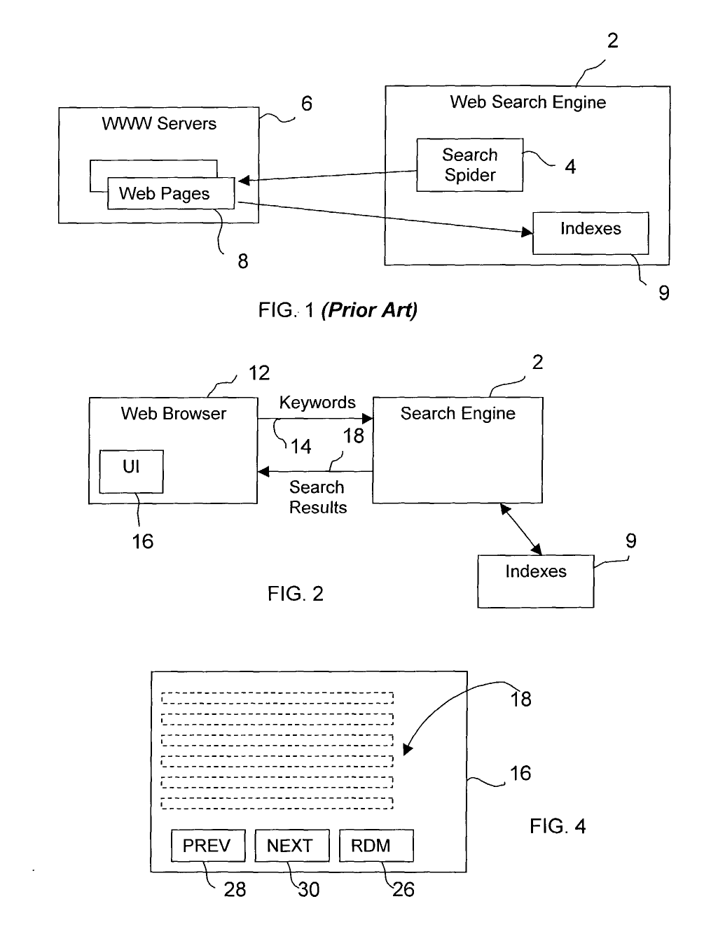

FIG. 1 is a diagram illustrating the searching of information by a Web search server or engine 2. The Web search engine 2 has at least one search spider 4 (also called a “crawler” or a “bot”) that periodically circulate among various interconnected Web servers 6 and visit various Web pages 8 that are geographically located all over the world. The Web search engine 2 analyzes the contents of the Web pages 8 and builds indexes 9, or references, that include relevant information about the Web pages 8 located on the various servers 6. The indexes 9 include summaries and uniform resource locators (URLs) for the Web pages 8 on the servers 6.

FIG. 2 is a diagram illustrating a system 10 for searching the Internet. A user uses a client program, known as a Web browser 12, on a computing device or system (FIG. 4) to access the Web search engine 2. To initiate a search query, the user enters one or more keywords 14 or arguments representing the type of information desired by the user on a user interface 16 provided by the browser 12. The one or more keywords 14 are transmitted to the Web search engine 2. On receiving the one or more keywords 14 the Web search engine 2 searches the previously generated indexes 9. The indexes 9 that contain information that are relevant to the one or more keywords 14 are returned as search results 18 to the search query.

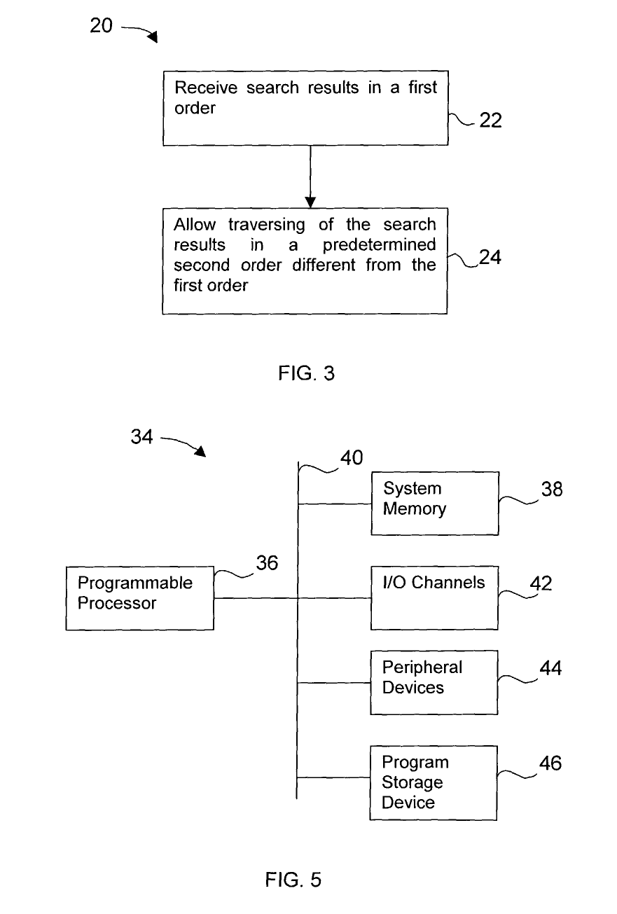

FIG. 3 illustrates a sequence 20 of steps for traversing the search results 18. The sequence 20 starts in a RESULTS AVAILABLE step 22, wherein the Web search engine 2 receives the search results 18 in a first order. This first order may be the result of ranking of the search results 18. The sequence 20 next proceeds to a PRESENT RESULTS step 24, wherein the browser 12 receives a first portion of the search results 18 from the Web search engine 2 and displays this first portion on the user interface 16 provided by the browser 12. The browser 12 allows the user to subsequently traverse the remaining search results in a predetermined or selected second order different from the first order. Ideally, the selected second order is randomly determined each time a same search query is made.

According to one embodiment of the present invention, the browser 12 receives either partially or wholly the search results 18 arranged in the first order. Traversing the search results in the selected second order is implemented by having the browser 12 reorder the search results 18 received in the first order in a different order that constitutes the second order. The user is then allowed to sequentially traverse the reordered search results by selection of indicia, such as a “previous” and a “next” button provided on the user interface 16.

The browser 12 reorders the search results 18 by first storing the search results 18 in an array. A pair of pseudo random numbers are then generated using conventional means. The positions of the search results in the array that is given by the pair of pseudo random numbers are swapped. This generation of pseudo random numbers and associated swapping of search results are repeated a predetermined number of times.

According to another embodiment of the present invention, traversing the search results 16 in the selected second order is made possible by providing a first indicium, such as a “random” button 26 (FIG. 4), on the user interface 16. Each selection or activation of this “random” button causes a request to be sent either to the browser 12 or the Web search engine 2. In response to the request, the browser 12 or the Web search engine 2 randomly selects a new portion or page of the search results, preferably not having been selected before, for display on the user interface 16. Such randomized selection of different portions of the search results 18 constitutes reordering of the search results 18. A user is therefore allowed to traverse the search results 18 in a second order different from the first order. The selected portions of the search results 18 are linked so that the user can trace back to a previously displayed portion by selecting a second indicium, such as a “previous” button 28 on the user interface 16. A third indicium, such as a “next” button 30 may also be provided to allow bidirectional traversing of the linked portions of the search results 18. With linking, selected portions of the search results become traceable.

FIG. 5 is a block diagram illustrating typical elements of a computing system 34 that is suitably programmed to perform the tasks of the Web browser 12 and the Web search engine 2 described above. The elements include a programmable processor 36 connected to a system memory 38 via a system bus 40. The processor 36 accesses the system memory 38 as well as other input/output (I/O) channels 42 and peripheral devices 44. The computing system 34 further includes at least one program storage device 46, such as a CD-ROM, tape, magnetic media, EPROM, EEPROM, ROM or the like. The computing system 34 stores one or more computer programs that implement a method of traversing search results as described above. The processor 36 reads and executes the one or more computer programs to perform the method.

Advantageously, the method for traversing search results described above gives a user a chance to reach search results that were otherwise unreachable or reachable only after tedious traversing using prior art means.

Although the present invention is described as implemented in the above-described embodiments, it is not to be construed to be limited as such. For example, the search results may be reordered at the Web search engine for subsequent transmitting to the browser.

As another example, the method of traversing search results is applicable to results returned by other search applications rather than limited to the application of Internet searching and browsing.

I claim:

1. A method for traversing search results from a search query comprising:
receiving the search results arranged in a first order; and
allowing traversing of the search results in a selected second order different from the first order.

2. A method according to claim 1, wherein the selected second order includes a random order.

3. A method according to claim 2, wherein allowing traversing of the search results in a selected second order includes:
reordering the search results received in the first order in the selected second order; and
allowing sequential traversing through the reordered search results.

4. A method according to claim 2, wherein allowing traversing of the search results in a selected second order includes allowing randomized traversing through separate portions of the received search results so that the search results are traversed in the selected second order.

5. A method according to claim 4, wherein allowing randomized traversing through the received search results includes allowing traceable randomized traversing through the received search results.

6. A method according to claim 5, wherein randomized traversing is initiated by selection of a first user-selectable indicium on a user interface on which the search results are displayed.

7. A method according to claim 6, wherein the user interface further includes a second user-selectable indicium which when selected sequentially returns the user to previously traversed search results.

8. A system for traversing search results comprising:
a search engine that receives search results arranged in a first order;
means for reordering the search results in a selected second order different from the first order; and
a user interface through which the reordered search results is traversable.

9. A system according to claim 8, wherein the selected second order includes a random order.

10. A system according to claim 9, wherein the means for reordering the search results in a random order includes means for reordering the search results received in the first order in the random order; and wherein the user interface through which the reordered search results is traversable includes a user interface through which the reordered search results is sequentially traversable.

11. A system according to claim 9, wherein the means for reordering the search results in a random order includes means for randomly selecting a portion of the search results for display on the user interface in response to a corresponding request.

12. A system according to claim 11, further including means for linking randomly selected portions so that the portions are traceable.

13. A system according to claim 12, wherein the user-interface includes a first indicium that is selectable to generate the request.

14. A system according to claim 13, wherein the user interface further includes a second user-selectable indicium which is selectable for sequentially traversing the linked portions of the search results.

15. A program storage device readable by a computing device, tangibly embodying a program of instructions, executable by the computing device to perform the method for traversing search results from a search query, the method comprising:
receiving the search results arranged in a first order; and
allowing traversing of the search results in a selected second order different from the first order.

16. A program storage device according to claim 15, wherein the selected second order includes a random order.

17. A program storage device according to claim 16, wherein allowing traversing of the search results in a selected second order includes:
reordering the search results received in the first order in the selected second order; and
allowing sequential traversing through the reordered search results.

18. A program storage device according to claim 17, wherein allowing traversing of the search results in a selected second order includes allowing randomized traversing through separate portions of the received search results so that the search results are traversed in the selected second order.

19. A program storage device according to claim 18, wherein allowing randomized traversing through the received search results includes allowing traceable randomized traversing through the received search results.

20. A program storage device according to claim 19, wherein randomized traversing is provided by a first user-selectable indicium on a user interface on which the search results are displayed.
